(19) United States
(12) Patent Application Publication
(10) Pub. No.: US 2004/0126665 A1
(43) Pub. Date: Jul. 1, 2004

(54) Gel polymer electrolyte battery and method of producing the same

(76) Inventor: Luying Sun, Randolph, NJ (US)

Correspondence Address: Lance Y. Liu, Mathews, Collins, Shepherd & McKay, P.A., Suite 306, 100 Thanet Circle, Princeton, NJ, 08540, US

(21) Appl. No.: 10/329,224

(22) Filed: Dec. 26, 2002

(51) Int. Cl. H01M 10/40

(52) U.S. Cl. 429/303; 429/300

(57) ABSTRACT

The present invention provides a gel polymer electrolyte battery which uses a polymerizable electrolyte polymerized within the battery case to form a gel polymer electrolyte without the addition of a polymerization initiator. The electrolyte of this invention can be produced by simply adding organic monomer to a conventional liquid electrolyte. The polymerizable electrolyte comprises a nonaqueous solvent, an electrolyte salt, and an organic monomer selected from the group consisting of vinyl ether and epoxide. Methods of making gel polymer electrolyte as well as polymer electrolyte battery are provided.

### FIELD OF THE INVENTION

The present invention relates generally to gel polymer electrolyte and its use in making gel polymer electrolyte batteries.

### BACKGROUND OF THE INVENTION

In the last decade, various attempts have been made to develop batteries which are safe to use, durable and have high power/battery weight ratio. These batteries have been widely used in cellular phones and other devices. They can potentially be used in electrically-powered vehicles which are more environmentally friendly and efficient in energy consumption than the current gasoline powered automobiles.

Gozdz et al. disclosed a plastic battery cell that is made by laminating a separator between positive and negative electrodes. (see U.S. Pat. No. 5,418,091, issued May 23, 1995 and U.S. Pat. No. 5,607,485, issued Mar. 4, 1997). The separator contains a polymer and a plasticizer, and is substantially devoid of pores. In the process of battery assembly, the membrane and the electrodes were laminated at high temperature and pressure and the plasticizer was extracted from the membrane with a volatile solvent so that the membrane becomes porous. Then, liquid electrolyte was added to the battery assembly to obtain a plastic battery. This process involves potentially increased cost and environmental pollution as it requires extraction of the plasticizer. Moreover, the current collect materials of electrodes for such battery must be in the form of grid or screen of metals such as aluminum grid and copper grid rather than metal foils such as aluminum foil and copper foil that have been commonly used for liquid lithium-ion batteries (“LLB”), which increases the cost of production.

Sun disclosed the use of solid polymer electrolyte films which are produced by in-situ polymerization of three monomers, together with a lithium salt and plasticizers in the batteries. (see U.S. Pat. No. 5,603,982, issued Feb. 18, 1997 and U.S. Pat. No. 5,609,974, issued Mar. 11, 1997). The resulting gel polymer electrolyte film can be closely attached to the electrodes when sealing the battery package under vacuum. However, as the lithium salts used in Sun is sensitive to moisture, the battery assembly operation has to be performed under anhydrous conditions, for example, in dry box under nitrogen or argon or in dry room. This substantially increases the cost of producing these types of batteries.

More recently, a number of U.S. patents have issued in the gel polymer electrolyte or gel polymer electrolyte battery (“PLB”) field. For example, U.S. Pat. Nos. 6,013,393 and 6,190,805 issued to Taniuchi et al disclose a polymerizable material comprising acrylate monomer; U.S. Pat. No. 6,235,433 issued to Amano et al describes a gel polymer electrolyte comprising polymerizable functional groups of unsaturated ethylene; U.S. Pat. No. 6,406,816 issued to Hikmet discloses polymer electrolyte made by polymerizing monomers of diacrylate; U.S. Pat. No. 5,654,112 issued to Itou et al; U.S. Pat. No. 6,210,513 issued to Hirata et al; U.S. Pat. No. 6,296,783 issued to Shindo et al; U.S. Pat. No. 6,372,388 issued to Katsurao et al.

An improved gel polymer battery has been developed to reduce the cost of production by eliminating the need of battery assembly in a dry-box and by using the same electrodes of the conventional liquid lithium-ion battery (“LLB”), i.e., positive and negative electrode materials coated onto aluminum foil and copper foil respectively. As disclosed in a U.S. Patent Application Publication No. 20010024756, a gel polymer lithium-ion battery has been made by using same liquid lithium-ion battery electrodes, separator and liquid electrolyte with the further addition of polymer precursor to the liquid electrolyte and subsequently curing the polymer precursor.

Despite of these improvements, the existing batteries still have the disadvantages of relying on free radical polymerization of the polymerizable monomers, such as acrylate or vinyl based compounds, to prepare the polymer electrolyte. As the free radical polymerization is usually carried out by thermal polymerization using peroxide type initiator, or by photo-polymerization or by polymerization using electron beam, γ-ray and X-ray, the polymerization may not take place inside of the negative electrode as well as in its vicinity and thus, the electrolyte inside negative electrode may still be in a state of liquid other than gel polymer. Moreover, the use of peroxide also creates safety concerns in the manufacturing process. Therefore, there is a need in the industry to develop polymer electrolyte and batteries that overcome these problems and have better performance.

### BRIEF SUMMARY OF THE INVENTION

One aspect of this invention is to develop a polymerizable electrolyte which can be polymerized through cationic polymerization rather than free radical polymerization to obtain a gel polymer electrolyte and to use the gel polymer electrolyte to produce gel polymer electrolyte batteries. The advantage of such gel polymer electrolyte is that the polymerizable electrolyte can be polymerized outside and inside of electrodes and separator membranes so that the gel polymer electrolyte can be uniformly distributed around the circumference of the assembled battery having a negative electrode, a positive electrode and a separator membrane.

Another aspect of the invention is directed to a gel polymer electrolyte battery which comprises (1) at least one positive electrode, (2) at least one negative electrode, (3) a separator membrane, and (4) a gel polymer electrolyte which comprises (i) a nonaqueous solvent, (ii) an electrolyte salt, and (iii) a polyvinyl ether, polyepoxide or a combination thereof. An advantage of the present battery is that the gel polymer electrolyte can be prepared by thermal cationic polymerization of a polymerizable electrolyte which contains (i) a nonaqueous solvent, (ii) an electrolyte salt, and (iii) a vinyl ether, epoxide, or a combinations thereof, without adding a polymerization initiator. Thus, the gel polymer electrolyte inside the battery does not contain a polymerization initiator.

A further aspect of the invention is directed to a method of producing the gel polymer electrolyte battery, comprising the steps of (a) assembling battery by sandwiching at least a separator membrane between at least a positive electrode and at least a negative electrode, (b) packaging the assembled battery cell into a battery case, (c) preparing polymerizable electrolyte containing (i) a vinyl ether or epoxide or a combination; (ii) a nonaqueous solvent and (iii) an electrolyte salt, without adding a polymerization initiator, (d) adding the polymerizable electrolyte into the battery case, and (e) heating the battery case at a temperature of from about 20 to about 120° C. to obtain said gel polymer electrolyte battery.

The contents of the patents and publications cited herein and the contents of documents cited in these patents and publications are hereby incorporated herein by reference to the extent permitted.

### REFERENCES

1. Gozdz et al, U.S. Pat. No. 5,418,091, issued May 23, 1995;

2. Gozdz et al, U.S. Pat. No. 5,607,485, issued Mar. 4, 1997;

3. Sun, U.S. Pat. No. 5,603,982, issued Feb. 18, 1997;

4. Sun, U.S. Pat. No. 5,609,974, issued Mar. 11, 1997;

5. Taniuchi et al, U.S. Pat. No. 6,013,393, issued Jan. 11, 2000;

6. Taniuchi et al, U.S. Pat. No. 6,190,805, issued Feb. 20, 2001;

7. Amano et al, U.S. Pat. No. 6,235,433, issued May 22, 2001;

8. Hikmet, U.S. Pat. No. 6,406,816, issued Jun. 18, 2002;

9. Itou et al, U.S. Pat. No. 5,654,112, issued Aug. 5, 1997;

10. Hirata et al, U.S. Pat. No. 6,210,513, issued Apr. 3, 2001;

11. Shindo et al, U.S. Pat. No. 6,296,783, issued Oct. 2, 2001;

12. Katsurao et al, U.S. Pat. No. 6,372,388, issued Apr. 16, 2002; and

13. Yamasaki, U.S. Patent Application No. 20010024756, Sep. 27, 2001.

### DETAILED DESCRIPTION

As used herein, the term “polyvinyl ether” includes, but is not limited to polymerization product of a vinyl ether monomer or a mixture of at least two different vinyl ether monomers. Preferably, the vinyl ether monomer is a divinyl ether, a trivinyl ether or a tetravinyl ether, more preferably a divinyl ether, and the most preferably, the divinyl ether has a chemical structure expressed in formula I:

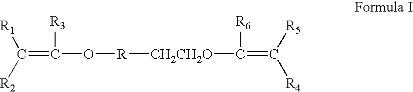

wherein R_{1,} R₂, R_{3,} R_{4,} R_{5,} R₆ are selected, independent of one another, from the group consisting of hydrogen, C₁₋₁₀ alkyl, fluorinated C₁₋₁₀ alkyl groups; wherein R is selected from C₁₋₁₀ alkyl, fluorinated C₁₋₁₀ alkyl, ethylene oxide unit having the structure:

—(CH₂CH₂O)ₙ—

wherein n is an integer of from 1 to 10.

The term “polyepoxide” generally means polymers obtained through the polymerization of an epoxide monomer or a mixture of at least two different epoxide monomers wherein the epoxide has one or more epoxy functional groups, preferably the epoxide monomer is a diepoxide, a triepoxide or a tetraepoxide, more preferably a diepoxide, and the most preferably the diepoxide has the chemical structure expressed in formula II:

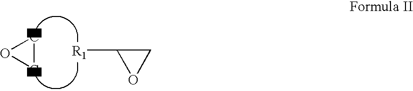

where in R₁ is selected from the group consisting of C₂₋₆ alkyl, fluorinated C₂₋₆ alkyl groups; or

formula III:

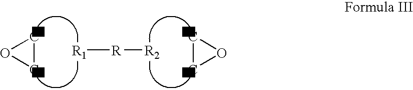

wherein R₁, and R₂ are selected, independent of each other, from the group consisting of C₂₋₆ alkyl, fluorinated C₂₋₆ alkyl groups. R is selected from C₁₋₁₀ alkyl group having ester, ketone, carbonate, or C₁₋₁₀ alkyl group having ethylene oxide group in either main chain or side chain.

As used herein, “monomer” generally includes vinyl ether and epoxide. “Vinyl ether” and “vinyl ether monomer” are used interchangeably and “epoxide” and “epoxide monomer” are also used interchangeably. Preferred monomers include tri(ethylene glycol)divinyl ether “TEGDVE”, di(ethylene glycol)divinyl ether “DEGDVE”, 4-vinyl-1-cyclohexene diepoxide “VCDE”, 3,4′-epoxycyclohexylmethyl 3,4-epoxycyclohexane carbonate “ECEC”. The polymerizable electrolyte could also be made by blending at least one of above divinyl ether or diepoxide together with mono-vinyl ether such as tri(ethylene glycol)methyl vinyl ether “TEGMVE”, 4-(1-propenyloxymethyl)-1,3-dioxalane-2-one “POMDO”, or with epoxide such as bis(3,4-epoxycyclohexylmethyl) adipate “BECA”, 1,4-butyanediol diglycidyl ether “BDE”, 1,2,7,8-diepoxyoctane “DEO”. The monomers can be used for making polymerizable electrolyte also include a mixture of above vinyl ether and epoxide.

The vinyl ether or epoxide is generally present in the gel polymer electrolyte in an amount of from about 0.5 to about 50%, preferably from about 0.8 to about 30% and more preferably from about 1 to about 10%.

The vinyl ether or epoxide generally has a molecular weight of about 1000 or less, preferably about 800 or less and more preferably about 300 or less.

As used herein, “polymerizable electrolyte” means a composition containing (i) a vinyl ether or an epoxide or a combination; (ii) a nonaqueous solvent and (iii) an electrolyte salt. Preferably the polymerizable electrolyte has a viscosity of about 200 centi-poise or less to facilitate the filling of the polymerizable electrolyte into the battery case. More preferably, the polymerizable electrolyte has a viscosity of about 50 centi-poise or less and more preferably about 10 centi-poise or less.

The negative electrode is usually made of metallic lithium or carboneous material such as coke or graphite. It can also be made from an intercalating metal oxide such as tungsten oxide or iron oxide. The positive electrode can be made of lithium compounds such as LiCoO₂, LiNiO₂, LiMn₂O₄, and LiCoₓNi₁₋ₓO₂ wherein the x is from 0.1 to 0.9. Material such as V₆O₁₃, MnO₂, FeS₂, CFₓ (carbon monofluoride) can also be used for making a positive electrode.

The positive electrode and the negative electrode are separated by at least one separator membrane such as (i) a polyolefin based porous polymer membrane, preferably made of polyethylene “PE”, polypropylene “PP”, or a combination of PE and PP, such as a trilayer PP/PE/PP membrane, (ii) heat-activatable microporous membranes as described in U.S. patent applications Ser. Nos. 10/034/388 and 10/034,494, the contents of which are incorporated herein by reference, (iii) porous materials made of fabric including glass or synthetic fabric (woven or non-woven fabric), (iv) porous membrane made of polymer materials such as poly(vinyl alcohol), poly(vinyl acetate), cellulose, and polyamide, etc.

The term “electrolyte salt” generally includes any salt that can be used in a lithium battery, preferably it is selected from LiPF₆, LiAsF₆, LiBF₄, LiClO₄, LiN(SO₂CF₃)₂, and lithium perfluoro-sulfonates. Lithium perfluoro-sulfonates generally include all the salts containing at least one lithium ion and a perfluoro-sulfonate anion. Preferably, the lithium perfluoro-sulfonate is LiSO₃CF₃, LiSO₃(CF₂)₃ CF₃, LiSO₃(CF₂)₉CF₃.

Nonaqueous solvent can be selected from any solvent or solvent mixture having a melting point lower than the room temperature. The solvent should dissolve lithium salts without causing hydrolysis. Moreover, the nonaqueous solvent is not limited to liquids. It can include solids, e.g., in a solid-liquid mixture. Preferably, the nonaqueous solvent is a C₁₋₁₀ alkyl cyclic carbonates, a C₁₋₁₀ linear carbonates, a C₁₋₁₀ alkyl cyclic esters, a C₁₋₁₀ alkyl linear esters, a C₁₋₁₀ alkyl cyclic ethers, a C₁₋₁₀ alkyl linear ethers, a glymes or their mixtures thereof, and more preferably, the nonaqueous solvent is a mixture of a C₁₋₁₀ linear carbonate, preferably ethylene carbonate and a C₁₋₁₀ alkyl linear ether.

As used herein, “polymerization initiator” that is not added to the polymerization process in making the gel polymer electrolyte includes boron trifluoride, boron trifluoride etherate, benzoyl peroxide, and azobis isobutyronitrile.

Without intending to be bound by any particular theory of operation, it is believed that the present plymerizable electrolyte can be polymerized without adding any polymerization initiators, i.e., boron trifluoride, boron trifluoride etherate, benzoyl peroxide, and azobis isobutyronitrile. It is also believed that it is possible that LiPF₆ electrolyte and the trace amount of hydrogen fluoride (HF) in the LiPF₆ electrolyte initiate the polymerization reaction of vinyl ether based monomers.

In a preferred embodiment, the method of producing the gel polymer electrolyte battery further comprises hermetically sealing the battery case. Generally, the battery case containing the electrodes and the polymerizable electrolyte is heated for at least about 30 seconds, preferably for a period of time from about 1 minute to about 300 minutes, more preferably from about 2 to about 200 minutes and the most preferably from about 5 to about 120 minutes.

In another preferred embodiment of the method, the vinyl ether is preferably divinyl ether and the epoxide is preferably diepoxide. More preferably, the divinyl ether has a chemical structure expressed in formula I:

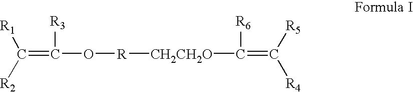

wherein R_{1,} R₂, R_{3,} R_{4,} R_{5,} R₆ are selected, independent of one another, from the group consisting of hydrogen, C₁₋₁₀ alkyl, fluorinated C₁₋₁₀ alkyl groups; wherein R is selected from C₁₋₁₀ alkyl, fluorinated C₁₋₁₀ alkyl, ethylene oxide unit having the structure:

—(CH₂CH₂O)ₙ—

wherein n is an integer of from 1 to 10.

The diepoxide preferably has the chemical structure expressed in formula II:

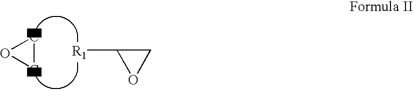

where in R₁ is selected from the group consisting of C₂₋₆ alkyl, fluorinated C₂₋₆ alkyl groups; or

formula III:

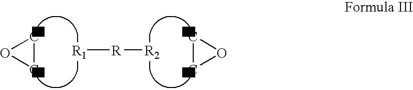

wherein R₁, and R₂ are selected, independent of each other, from the group consisting of C₂₋₆ alkyl, fluorinated C₂₋₆ alkyl groups. R is selected from C₁₋₁₀ alkyl group having ester, ketone, carbonate, or C₁₋₁₀ alkyl group having ethylene oxide group in either main chain or side chain.

In another preferred embodiment, liquid electrolyte is made by dissolving electrolyte salt in nonaqueous solvent. The electrolyte salt is preferably lithium salt which is selected from the group consisting of LiPF₆, LiAsF₆, LiBF₄, LiClO₄, LiN(SO₂CF₃)₂, and lithium perfluoro-sulfonates. Preferably, the lithium salt is LiPF₆.

In a further preferred embodiment, the nonaqueous solvent is selected from the group consisting of alkyl cyclic carbonates, linear carbonates, alkyl cyclic esters, alkyl linear esters, alkyl cyclic ethers, alkyl linear ethers, glymes and combinations thereof. Examples of this nonaqueous solvent include ethylene carbonate “EC”, diethyl carbonate “DEC”, dimethyl carbonate “DMC”, propylene carbonate “PC”, methyl ethyl carbonate “MEC”, butyrolactone. Preferably, the nonaqueous solvent is a mixture of EC, DEC and DMC.

Without intending to be bound by any particular theory of operation, it is believed that the polymerizable electrolyte has low viscosity and can be injected into battery case using a process known in the conventional liquid lithium-ion battery technology. It is also believed that the present polymerizable electrolyte can be polymerized without the addition of an initiators and the mechanism of the cationic polymerization is HF catalyzed polymerization which is initiated by the trace amount of HF that exists in the electrolyte.

In another preferred embodiment, the viscosity of the polymerizable electrolyte is about 200 centi-poise (“cps”) or less, more preferably about 50 cps or less, and the most preferably 10 cps or less at ambient temperature of between from about 20 to about 28° C.

In another preferred embodiment, the weight percentage of monomers as of total polymerizable electrolyte is from about 1 to 50%, preferably from about 1 to 30%, and more preferably from about 2 to 10%.

In another preferred embodiment, the polymerizable electrolyte can be polymerized by heating at a temperature of from about 20 to about 120° C. for a period of time from about 5 to 120 minutes to form gel polymer electrolyte.

Without intending to be bound by any particular theory of operation, it is believed that the present gel polymer electrolyte increases the performance of the battery by reducing the complexity of the battery assembly and increasing electrolyte-membrane-electrode contacts. It is also believed that the gel polymer electrolyte battery is free of liquid and eliminates the possibilities of electrolyte leakage and of dangerous increase in pressure which sometimes occur when volatile liquid electrolytes are present in the batteries. With the use of divinyl ether or diepoxide based monomers, the resulting polymer has a cross-linked structure which is stable toward heat and physical stress.

The following examples are given as specific illustrations of the invention. It should be understood, however, that the invention is not limited to the specific details set forth in the examples. All parts and percentages in the examples, as well as in the remainder of the specification, are by weight unless otherwise specified.

Further, any range of numbers recited in the specification or paragraphs hereinafter describing or claiming various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for, or in conjunction with, a variable, is intended to convey that the numbers and ranges disclosed herein are flexible and that practice of the present invention by those skilled in the art using temperatures, concentrations, amounts, contents, carbon numbers, and properties that are outside of the range or different from a single value, will achieve the desired result, namely, a gel polymer electrolyte and a gel polymer electrolyte battery and methods for preparing such electrolyte and battery.

### EXAMPLE 1

A polymerizable electrolyte was prepared in a dry-box under nitrogen which having less than 1 ppm moisture. 0.207 g of tri(ethylene glycol)methyl vinyl ether, “TEGMVE”, was mixed with 0.058 g of tri(ethylene glycol)divinyl ether, “TEGDVE”, in a glass bottle at a TEGMVE:TEGDVE weight ratio of about 4:1. Then, 0.502 g of 1.2M LiPF₆ electrolyte was prepared by dissolving desired amount of LiPF₆ in a solvent of ethylene carbonate/diethyl carbonate/dimethyl carbonate “EC/DEC/DMC” in a proportion of 2:1:1 in weight ratio. The LiPF₆ solution was added to the TEGMVE-TEGDVE mixture to form a polymerizable electrolyte solution in which the amount of TEGMVE and TEGDVE as a percentage of the total polymerizable solution was about 35%. Then, the polymerizable electrolyte solution was polymerized by storing at a temperature of about 23° C. for about 15 hours to obtain a gel polymer electrolyte. It was found that the gel polymer electrolyte was homogeneous, transparent, colorless, and contains no free liquid. Testing data for the gel polymer electrolyte of this example are shown as Sample No. 5 in Table 1.

### EXAMPLE 2

In the same procedure as described in Example 1, a polymerizable electrolyte was prepared by mixing 0.166 g of tri(ethylene glycol)methyl vinyl ether, “TEGMVE”, with 0.05 g of di(ethylene glycol)divinyl ether, “DEGDVE”, in a weight ratio of about 3:1. Then 3.798 g of 1.2M LiPF₆ EC:DEC:DMC (in a 2:1:1 weight ratio) electrolyte was added to the TEGMVE DEGDVE mixture to obtain a polymerizable solution, in which TEGMVE and DEGDVE constitute about 5% of the resulting polymerizable solution. The polymerizable electrolyte was then heated at a temperature of 65° C. for about 10 minutes to obtain a gel polymer electrolyte which was homogeneous, colorless, and free of liquid. Testing data regarding the gel polymer electrolyte of this example are shown in Table 1 as Sample No.10.

### EXAMPLE 3

Based on the same procedure as described in Example 1, a polymerizable electrolyte was prepared by mixing 0.10 g of 4-vinyl-1-cyclohexene diepoxide “VCDE” with 2.00 g of 1.2M LiPF₆ EC:DEC:DMC (2:1:1) electrolyte. VCDE constitutes about 5% of the resulting polymerizable solution. Then, the polymerizable electrolyte was heated at a temperature of about 65° C. for about one hour to obtain a gel polymer electrolyte which was homogeneous, pale yellowish, and free of liquid. Testing data regarding the gel polymer electrolyte of this example are shown in Table 1 as Sample No. 14.

### EXAMPLE 4

Following the same procedures as described in Example 1, various gel polymer electrolytes were prepared with different monomer % and polymerization time. The testing data are listed in Table 1, Samples 1-4, 6-9, 11-13 and 15-22, respectively.

### Table 1

Table 1 summarizes the testing data of polymerizable electrolyte from Examples Nos. 1-22. They were prepared by the use of various monomers in different stoichiometric ratios. These monomers include tri(ethylene glycol)divinyl ether “TEGDVE”, tri(ethylene glycol)methyl vinyl ether “TEGMVE”, di(ethylene glycol)divinyl ether “DEGDVE”, 4-(1-propenyloxymethyl)-1,3-dioxalane-2-one “POMDO”, 4-vinyl-1-cyclohexene diepoxide “VCDE”, 3,4′-epoxycyclohexylmethyl 3,4-epoxycyclohexane carbonate “ECEC”.

TABLE 1

| | | Electrolyte | | |
|---|---|---|---|---|
| Sam- | Monomers: | (1.2 M LiPF₆ | Percen- | |
| ple | weight ratio | EC/DEC/DMC) | tage of | |
| No. | weight in gram | (g) | monomers | Results |
| 1 | TEGDVE/ 0.206 | 0.408 | 34 | Clear gel polymer |
| | | | | formed in a few |
| | | | | seconds at RT |
| 2 | TEGMVE/ 0.239 | 0.415 | 36 | Viscous, but no gel |
| | | | | polymer formed |
| 3 | TEGMVE/ TEGDVE: | 0.897 | 34 | Clear gel polymer |
| | 2/1 0.308/0.159 | | | formed in 30 |
| | | | | seconds at RT |
| 4 | TEGMVE/ TEGDVE: | 0.807 | 34 | Gel polymer formed |
| | 3/1 0.302/0.111 | | | in a minute at RT |
| 5 | TEGMVE/ TEGDVE: | 0.502 | 35 | Gel polymer formed |
| | 4/1 0.207/0.058 | | | in 15 hours at RT |
| 6 | TEGMVE/ TEGDVE: | 0.925 | 33 | Gel polymer formed |
| | 8/1 0.404/ 0.050 | | | but with free |
| | | | | liquid, i.e. |
| | | | | phase separation |
| 7 | DEGDVE/ 0.125 | 0.760 | 14 | Gel formed quickly |
| 8 | DEGDVE/POMDO: | 0.620 | 33 | Rubber-like gel |
| | 1/1 0.156/0.155 | | | formed |
| 9 | DEGDVE/ | 2.0 | 5 | Polymerized as soon |
| | 0.1 | | | as electrolyte was |
| | | | | added |
| 10 | TEGMVE/ DEGDVE: | 3.798 | 5 | Gel polymer formed |
| | 3/1 0.166/0.05 | | | in 10 min. at |
| | | | | 65° C. |
| 11 | TEGDVE/ | 1.876 | 10 | Gel polymer formed |
| | 0.213 | | | in 15 hr at room |
| | | | | temp. |
| 12 | TEGMVE/ TEGDVE: | 0.532 | 33 | Gel polymer formed |
| | 4/1 0.209/0.062 | | | in 15 min. at |
| | | | | 65° C. |
| 13 | TEGMVE/ TEGDVE: | 0.989 | 23 | Gel polymer formed |
| | 3/1 0.219/0.076 | | | in 1 hr at 65° C. |
| 14 | VCDE/ 0.10 | 2.00 | 5 | Gel polymer (hard) |
| | | | | formed in 1 hr |
| | | | | at 65° C. |
| 15 | VCDE | 3.00 | 5 | Gel polymer formed |
| | 0.15 | | | in 21 hr at RT |
| 16 | VCDE | 3.75 | 4 | Gel polymer formed |
| | 0.15 | | | in 21 hr at RT |
| 17 | VCDE | 3.33 | 3 | Gel polymer formed |
| | 0.10 | | | in 20 hr at RT |
| 18 | VCDE | 5.00 | 2 | After stored at RT |
| | 0.10 | | | for 2 days, heated |
| | | | | at 65° C., gel |
| | | | | polymer formed |
| | | | | in 1 hr |
| 19 | ECEC | 2.00 | 5 | Gel polymer (soft) |
| | 0.10 | | | formed in 1 hr |
| | | | | at 65° C. |
| 20 | ECEC | 3.00 | 5 | Gel polymer formed |
| | 0.15 | | | in 6 days at RT |
| 21 | ECEC | 3.00 | 5 | After stored at RT |
| | 0.15 | | | for 48 hr, heated |
| | | | | at 65° C., gel |
| | | | | polymer formed |
| | | | | in 1 hr |
| 22 | ECEC | 3.75 | 4 | No gel polymer |
| | 0.15 | | | in 2 hr at |
| | | | | 65° C. |

In Table 1, the abbreviations are as follows: TEGDVE, tri(ethylene glycol) divinyl ether; TEGMVE, tri(ethylene glycol)methyl vinyl ether; DEGDVE, di(ethylene glycol)divinyl ether; POMDO, 4-(1-propenyloxymethyl)-1,3-dioxalane-2-one; VCDE, 4-vinyl-1-cyclohexene diepoxide; ECEC, 3,4′-epoxycyclohexylmethyl 3,4-epoxycyclohexane carbonate; EC, ethylene carbonate; DEC, diethyl carbonate; DMC, dimethyl carbonate; RT, room temperature.

### EXAMPLE 5

### Mechanism of Polymerization

As summarized in Table 2, three polymerizable electrolyte Samples Nos. 23, 24, and 25 were prepared by mixing 0.10 g of di(ethylene glycol)divinyl ether “DEGDVE” with 2.0 g of 1.2M, 0.7M, and 0.3M of LiPF₆ EC:DEC:DMC (2:1:1) electrolytes respectively. The resulting polymerizable electrolyte was polymerized at room temperature of 23° C. It was found that the polymerization speed is proportional to the molar concentration of LiPF₆. When the concentration of LiPF₆ EC:DEC:DMC (2:1:1) electrolyte was reduced from 1.2M to 0.3M, the polymerization speed slowed down from “polymerized immediately” to about one hour.

Three other samples, Sample Nos. 26, 27, and 28, were prepared by mixing divinyl ethers DEGDVE or TEGDVE with 1.2M LiPF₆ EC:DEC:DMC (2:1:1) electrolyte which contained 1% pyridine.

When 1% pyridine was added to the 1.2M electrolyte, as shown in Table 2, the polymerization did not take place at room temperature or at 65° C. or 90° C. for one hour.

Four additional samples, Sample Nos. 29-32, were prepared with the use of diepoxide based monomer including 4-vinyl-1-cyclohexene diepoxide “VCDE”, and 3,4′-epoxycyclohexylmethyl 3,4-epoxycyclohexane carbonate, “ECEC”. The former two samples, Sample Nos. 29 and 30, were prepared by mixing 0.1 g of VCDE with 2.0 g of 0.7M and 0.3M LiPF₆ electrolytes respectively. As indicated in Table 2, both samples polymerized in one hour at 65° C. The latter two samples, Sample Nos. 31 and 32, were prepared by mixing di-epoxide monomers VCDE or ECEC with 1.2M LiPF₆ electrolyte containing about 1% pyridine. These two samples could not be polymerized.

TABLE 2

| | | Molar | | 1.2 M LiPF₆ | | |
|---|---|---|---|---|---|---|
| | | concentration of | | electrolyte | Percentage | |
| Sample | Monomer | LiPF₆ electrolyte, | | containing 1% | of | |
| No. | (g) | wt. of electrolyte | | pyridine | monomers | Results |
| 23 | DEGDVE | 1.2 | M | None | 5 | Polymerized immediately |
| | 0.10 | 2.00 | g | | | after the addition of |
| | | | | | | electrolyte |
| 24 | DEGDVE | 0.7 | M | None | 5 | Colorless gel polymer |
| | 0.10 | 2.00 | g | | | formed immediately after the |
| | | | | | | addition of electrolyte |
| 25 | DEGDVE | 0.3 | M | None | 5 | Colorless gel polymer |
| | 0.10 | 2.00 | g | | | formed in 1 hr at RT |
| 26 | DEGDVE | None | | 2.00 g | 5 | No polymer obtained in two |
| | 0.10 | | | | | days |
| 27 | DEGDVE | None | | 2.00 g | 5 | No polymer obtained at RT, |
| | 0.10 | | | | | or 65° C./1 hr, or 90° C./1 hr |
| 28 | TEGDVE | None | | 2.00 g | 10 | No polymer obtained at RT, |
| | 0.20 | | | | | or 65° C./1 hr, or 90° C./1 hr |
| 29 | VCDE | 0.7 | M | None | 5 | Gel polymer formed in 1 hr |
| | 0.10 | 2.0 | g | | | at 65° C. |
| 30 | VCDE | 0.3 | M | None | 5 | Half formed gel in 1 hr at |
| | 0.10 | 2.0 | g | | | 65° C., >90% formed gel in |
| | | | | | | 1 hr at 90° C. |

| | | | | | |
|---|---|---|---|---|---|
| 31 | VCDE | None | 2.00 g | 5 | No polymer obtained at RT, |
| | 0.10 | | | | or 65° C./1 hr, or 90° C./1 hr |
| 32 | ECEC | None | 2.00 g | 5 | No polymer obtained at RT, |
| | 0.10 | | | | or 65° C./1 hr, or 90° C./1 hr |

In Table 2, the abbreviations are as follows: DEGDVE, di(ethylene glycol) divinyl ether; TEGDVE, tri(ethylene glycol)divinyl ether; VCDE, 4-vinyl-1-cyclohexene diepoxide; ECEC, 3,4′-epoxycyclohexylmethyl 3,4-epoxycyclohexane carbonate; RT, room temperature.

### EXAMPLE 6

### Polymerization in the Presence of Electrodes

For some polymerization such as free radical polymerization, monomer may not polymerize inside the negative electrode because the active carbon material could consume free radical species of initiators. One of the requirements for polymerizable electrolyte is that it should polymerize outside as well as inside of electrodes and separator membranes. Accordingly, it should be examined that the polymerization of polymerizable electrolyte in the presence of electrodes.

Two polymerizable electrolytes, Samples Nos. 33 and 34 as shown in Table 3, were prepared by mixing 0.10 g of 4-vinyl-1-cyclohexene diepoxide “VCDE” with 2.00 g of 1.2M LiPF₆ EC/DEC/DMC (2/1/1) electrolyte. Then, to Sample No. 33, was added 4 pieces of negative electrode with a dimension of 5×10 mm which was double-side coated negative electrode for lithium-ion battery comprising about 90% active carbon material produced by Hitachi Maxell Ltd. of Osaka, Japan. While, to Sample No 34, was added 4 pieces of positive electrode with a dimension of 5×10 mm which was double-side coated positive electrode for lithium-ion battery comprising about 91% active LiCoO₂ material produced by Hitachi Maxell Ltd. of Osaka, Japan. After heated at a temperature of 65° C. for 1 hour, both samples polymerized. It was found the polymerizable electrolyte polymerized outside as well as inside of negative and positive electrodes.

Other two polymerizable electrolyte samples, Sample Nos. 35 and 36 as shown in Table 3, were prepared by mixing 0.10 g of 3,4′-epoxycyclohexylmethyl 3,4-epoxycyclohexane carbonate “ECEC” with 2.00 g of 1.2M LiPF₆ EC/DEC/DMC (2/1/1) electrolyte. Then, to Samples Nos. 35 and 36, were added 4 pieces of negative electrode and 4 pieces of positive electrode with a dimension of 5×10 mm respectively. After heated at a temperature of 65° C. for 1 hour, both samples polymerized. It was found the polymerization occurred outside as well as inside of negative and positive electrodes.

TABLE 3

| | | Electrolyte | | | |
|---|---|---|---|---|---|
| | | (1.2 M | Per- | | |
| Sam- | Mono- | LiPF₆ | centage | | |
| ple | mer | EC/DEC/DMC) | of | | |
| No. | (g) | (g) | monomer | Electrode | Results |
| 33 | VCDE | 2.00 | 5 | Negative | Firm gel |
| | 0.10 | | | electrode | polymer |
| | | | | 4 pcs | obtained in |
| | | | | | 1 h at 65° C. |
| 34 | VCDE | 2.00 | 5 | Positive | Firm gel |
| | 0.10 | | | electrode | polymer |
| | | | | 4 pcs | obtained in |
| | | | | | 1 h at 65° C. |
| 35 | ECEC | 2.00 | 5 | Negative | Soft gel |
| | 0.10 | | | electrode | polymer |
| | | | | 4 pcs | formed in |
| | | | | | 1 h at 65° C. |
| 36 | ECEC | 2.00 | 5 | Positive | Soft gel |
| | 0.10 | | | electrode | polymer |
| | | | | 4 pcs | formed in |
| | | | | | 1 h at 65° C. |

In Table 3, the abbreviations are as follows: VCDE, 4-vinyl-1-cyclohexene diepoxide; ECEC, 3,4′-epoxycyclohexylmethyl 3,4-epoxycyclohexane carbonate; EC, ethylene carbonate; DEC, diethyl carbonate; DMC, dimethyl carbonate.

### EXAMPLE 7

### Ionic Conductivity of Gel Polymer Electrolyte

A polymerizable electrolytes sample was prepared by mixing 0.20 g of 4-vinyl-1-cyclohexene diepoxide “VCDE” with 4.00 g of 1.2M LiPF₆ EC/DEC/DMC (2/1/1) electrolyte. Then, about 0.4 g of the polymerizable electrolyte solution was spread onto a piece of Celgard® 2300 separator membrane made by Celgard Inc. of Charlotte, N.C., with a dimension of 35×35 mm. The separator membrane was supported on a copper foil. After being stored at room temperature for 4 hours to let electrolyte diffuse into separator membrane. Then, the ionic conductivity of electrolyte was measured. Subsequently, it was heated at 65° C. for 1 hour for polymerization. After cooled to room temperature, the gel polymer electrolyte/Celgard separator membrane was subjected to ionic conductivity measurement again at ambient temperature of about 23° C. The measurement was conducted through AC impedance measurement by scanning from 500 kHz to 0.5 Hz. Data related to this sample are recorded in Table 4 as Sample 37. The conductivity before and after polymerization is 0.722±0.024 and 0.627±0.071 mS/cm respectively.

Sample No. 38 was made with the same polymerizable electrolyte described above for Sample No. 37 except with a substitution of Teklon™ separator membrane made by Entek Membranes LLC of Lebanon, Oreg., for Celgard® separator membrane. As shown in Table 4, the conductivity before and after polymerization is 0.861±0.020 and 0.805±0.021 mS/cm respectively.

Sample No. 39 was made with the same polymerizable electrolyte described above for Sample No. 37 except with a substitution of heat-activatable separator membrane made in-house (patent applications Ser. Nos. 10/034,388 and 10/034,494) for Celgard® separator membrane. As shown in Table 4, the conductivity before and after polymerization is 1.155±0.089 and 0.930±0.065 mS/cm respectively.

TABLE 4

| | | | Ionic conductivity of gel polymer | |
|---|---|---|---|---|
| | | Type of | electrolyte (mS/ cm) | |
| Sample | Polymerizable | separator | before | after |
| No. | electrolyte | membrane | polymerization | polymerization |
| 37 | 5% VCDE in | Celgard ® | 0.722 ± 0.024 | 0.627 ± 0.071 |
| | 1.2 M LiPF₆ | | | |
| 38 | 5% VCDE in | Teklon ™ | 0.861 ± 0.020 | 0.805 ± 0.021 |
| | 1.2 M LiPF₆ | | | |
| 39 | 5% VCDE in | PTI heat- | 1.155 ± 0.089 | 0.930 ± 0.065 |
| | 1.2 M LiPF₆ | activatable | | |
| | | separator | | |

In Table 4, the abbreviation is as follows: VCDE, 4-vinyl-1-cyclohexene diepoxide.

### EXAMPLE 8

### Polymer Electrolyte Batteries

A lithium-ion rechargeable battery was assembled using a carbon negative electrode, a LiCoO₂ positive electrode, and a conventional battery separator membrane. Into the assembled battery case, was injected the polymerizable electrolyte of this invention which resulted in gel polymer electrolyte after its polymerization. Both negative and positive electrodes were conventional liquid lithium-ion battery electrodes, namely negative electrode containing about 90% active carbon material, and the positive electrode containing about 91% active LiCoO₂ which were produced by Hitachi Maxell Ltd. of Osaka, Japan.

A Teklon™ separator membrane made by Entek Membrane LLC of Lebanon, Oreg., with a dimension of 38 mm by 45 mm was sandwiched between a positive electrode 30 mm by 38 mm and a negative electrode 32 mm by 40 mm, i.e. the battery having a total active area of 11 cm². The battery was packaged and partially sealed in an aluminum foil-laminated plastic bag. After the battery was fully dried, it was transferred into a dry-box under nitrogen which having less than 1 ppm moisture. About 0.4 g of polymerizable electrolyte containing 2% of 4-vinyl-1-cyclohexene diepoxide, “VCDE”, was injected into the battery, wherein the polymerizable electrolyte was prepared by mixing 0.20 g of VCDE made by Sigma-Aldrich Inc. of Milwaukee, Wis., with 4.00 g of 1.2M LiPF₆ EC:DEC:DMC (2:1:1) electrolyte which was prepared by dissolving LiPF₆ salt produced by Stella Chemifa Corp. of Osaka, Japan, into a solution of ethylene carbonate/diethyl carbonate/dimethyl carbonate in a proportion of 2:1:1. The battery was completely sealed, and then was heated at a temperature of 65° C. for 1 hour for the polymerization of polymerizable electrolyte to result in gel polymer electrolyte. After cooled to room temperature, the battery was subjected to charge/discharge performance test and AC impedance measurement. Data concerning this battery are set forth in Table 5 as Battery No. Cell01.

A second battery, Battery No. Cell02, was made in the same manner as Battery No. Cell01.

A third battery was made in the same manner as described above for Battery No. Cell01 with a substitution of a polymerizable electrolyte containing 5% of 3,4′-epoxycyclohexylmethyl 3,4-epoxycyclohexane carbonate, “ECEC”, made by Sigma-Aldrich Inc. of Milwaukee, Wis., for 2% VCDE polymerizable electrolyte. Testing data related to this battery are recorded in Table 5 as Battery No. Cell03.

For comparison, other two batteries, Battery Nos. Cell04 and Cell05, were made as control battery in the same way as described above for Battery No. Cell01 except with a substitution of 1.2M LiPF₆ EC:DEC:DMC (2:1:1) liquid electrolyte in place of 2% VCDE polymerizable electrolyte. Data including discharge capacity and impedance of these two batteries are recorded in Table 5.

As indicated in Table 5, gel polymer electrolyte batteries showed a little lower capacity and slightly higher impedance than liquid electrolyte batteries (control) due to the decrease of ionic conductivity since the mobility of ion is reduced when the state of electrolyte changed from liquid to solid or gel solid.

At the end of tests, gel polymer electrolyte batteries, Nos. Cell 01-03, were disassembled and it was found that the gel polymer electrolyte was uniformly distributed around the circumference of electrodes and separator membrane. The polymerizable electrolyte polymerized outside as well as inside electrodes without free liquid. Besides the advantage of free of liquid, it is believed the gel polymer electrolyte should have other advantages including longer cycle life and improved battery safety.

TABLE 5

| | | Discharge | Cell |
|---|---|---|---|
| Battery | | capacity | impedance |
| No. | Electrolyte | (mAh) | (Ω) |
| Cell 01 | 2% VCDE polymer | 30.10 | 0.396 |
| | electrolyte | | |
| Cell 02 | 2% VCDE polymer | 30.60 | 0.538 |
| | electrolyte | | |
| Cell 03 | 5% ECEC polymer | 32.98 | 0.510 |
| | electrolyte | | |
| Cell 04 | Liquid electrolyte | 32.28 | 0.367 |
| Cell 05 | Liquid electrolyte | 32.82 | 0.323 |

In Table 5, the abbreviations are as follows: VCDE, 4-vinyl-1-cyclohexene diepoxide; ECEC, 3,4′-epoxycyclohexylmethyl 3,4-epoxycyclohexane carbonate.

What is claimed is:

1. A gel polymer electrolyte battery comprising (1) at least one positive electrode, (2) at least one negative electrode, (3) a separator membrane, and (4) a gel polymer electrolyte which comprises (i) a nonaqueous solvent, (ii) an electrolyte salt, and (iii) a polyvinyl ether, polyepoxide or a combination thereof, and (iv) without the presence of a polymerization initiator.

2. The gel polymer electrolyte battery of claim 1, wherein said gel polymer electrolyte is prepared by thermal cationic polymerization of a polymerizable electrolyte which comprises (a) a nonaqueous solvent, (b) an electrolyte salt, and (c) a vinyl ether, epoxide, and a combinations thereof, without adding a polymerization initiator.

3. The gel polymer electrolyte battery of claim 2, wherein the vinyl ether is a divinyl ether, a trivinyl ether or a tetravinyl ether.

4. The polymerizable electrolyte of claim 2, wherein the epoxide is a diepoxide, a triepoxide or a tetraepoxide.

5. The gel polymer electrolyte battery of claim 2, wherein said vinyl ether is a divinyl ether and said epoxide is a diepoxide.

6. The gel polymer electrolyte battery of claim 5, wherein said divinyl ether has a chemical structure expressed in formula I: 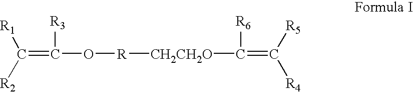
wherein R_{1,} R₂, R_{3,} R_{4,} R_{5,} R₆ are selected, independent of one another, from the group consisting of hydrogen, C₁₋₁₀ alkyl, fluorinated C₁₋₁₀ alkyl groups; wherein R is selected from C₁₋₁₀ alkyl, fluorinated C₁₋₁₀ alkyl, ethylene oxide unit having the structure:
—(CH₂CH₂O)ₙ—
wherein n is an integer of from 1 to 10.

7. The gel polymer electrolyte battery of claim 5, wherein said diepoxide has the chemical structure expressed in formula II: 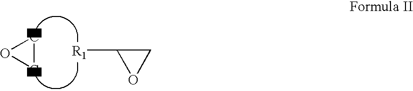
where in R₁ is selected from the group consisting of C₂₋₆ alkyl, fluorinated C₂₋₆ alkyl groups; or formula III: 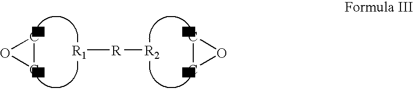
wherein R₁, and R₂ are selected, independent of each other, from the group consisting of C₂₋₆ alkyl, fluorinated C₂₋₆ alkyl groups. R is selected from C₁₋₁₀ alkyl group having ester, ketone, carbonate, or C₁₋₁₀ alkyl group having ethylene oxide group in either main chain or side chain.

8. The gel polymer electrolyte battery of claim 1, wherein said nonaqueous solvent is selected from the group consisting of C₁₋₁₀ alkyl cyclic carbonates, C₁₋₁₀ linear carbonates, C₁₋₁₀ alkyl cyclic esters, C₁₋₁₀ alkyl linear esters, C₁₋₁₀ alkyl cyclic ethers, C₁₋₁₀ alkyl linear ethers, glymes and mixtures thereof.

9. The gel polymer electrolyte battery of claim 1, wherein said electrolyte salt is a lithium salt selected from the group consisting of LiPF₆, LiAsF₆, LiBF₄, LiClO₄, LiN(SO₂CF₃)₂, and lithium perfluoro-sulfonates.

10. The gel polymer electrolyte battery of claim 2, wherein said vinyl ether or said epoxide is present in an amount of from about 0.5 to about 50%.

11. The gel polymer electrolyte battery of claim 2, wherein said vinyl ether or said epoxide is present in an amount of from about 1 to about 10%.

12. The gel polymer electrolyte battery of claim 2, wherein said polymerizable electrolyte has a viscosity of 200 centi-poise or less.

13. The gel polymer electrolyte battery of claim 2, wherein said polymerizable electrolyte has a viscosity of 10 centi-poise or less.

14. The gel polymer electrolyte battery of claim 2, wherein said vinyl ether or said epoxide has a molecular weight of 1000 or less.

15. The gel polymer electrolyte battery of claim 2, wherein said vinyl ether or said epoxide has a molecular weight of 300 or less.

16. A method of producing the gel polymer electrolyte battery of claim 1, comprising the steps of (a) assembling battery by sandwiching at lease a separator membrane between at least a positive electrode and at least a negative electrode, (b) packaging the assembled battery cell into a battery case, (c) preparing polymerizable electrolyte containing (i) a vinyl ether or epoxide or a combination; (ii) a nonaqueous solvent and (iii) an electrolyte salt, without adding a polymerization initiator, (d) adding the polymerizable electrolyte into the battery case, and (e) heating the battery case at a temperature of from about 20 to about 120° C. to obtain said gel polymer electrolyte battery.

17. The method of claim 16, further comprising hermetically sealing the battery case.

18. The method of claim 16, wherein said battery case is heated for a period of time from about 5 to 120 minutes.

19. The method of claim 16, wherein said vinyl ether is divinyl ether and said epoxide is diepoxide.

20. The method of claim 19, wherein said divinyl ether has a chemical structure expressed in formula I: 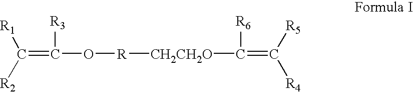
wherein R_{1,} R_{2,} R_{3,} R_{4,} R_{5,} R₆ are selected, independent of one another, from the group consisting of hydrogen, C₁₋₁₀ alkyl, fluorinated C₁₋₁₀ alkyl groups; wherein R is selected from C₁₋₁₀ alkyl, fluorinated C₁₋₁₀ alkyl, ethylene oxide unit having the structure:
—(CH₂CH₂O)ₙ—
wherein n is an integer of from 1 to 10.

21. The method of claim 19, wherein said diepoxide has the chemical structure expressed in formula II: 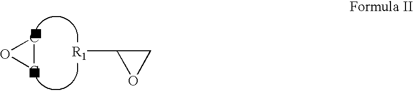
where the group consisting of C₂₋₆ alkyl, fluorinated C₂₋₆ alkyl groups; or
formula III: 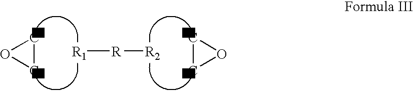
wherein R₁, and R₂ are selected, independent of each other, from the group consisting of C₂₋₆ alkyl, fluorinated C₂₋₆ alkyl groups. R is selected from C₁₋₁₀ one, carbonate, or C₁₋₁₀ alkyl group having ethylene oxide group in either main chain or side chain.
